(19) United States
(12) Patent Application Publication
(10) Pub. No.: US 2016/0351328 A1
(43) Pub. Date: Dec. 1, 2016

(54) COUPLING ENHANCEMENT INTERMEDIARY COIL FOR TAG COMMUNICATION STANDARDIZATION

(71) Applicant: Xerox Corporation, Norwalk, CT (US)

(72) Inventors: CHRISTOPHER P. CAPORALE, ROCHESTER, NY (US); SCOTT J. BELL, ROCHESTER, NY (US); ALBERTO RODRIGUEZ, WEBSTER, NY (US); Trong Ngoc Duong, Cicero, NY (US)

(21) Appl. No.: 14/722,516

(22) Filed: May 27, 2015

(51) Int. Cl. H01F 38/14; G03G 21/18; G06K 7/10

(52) U.S. Cl. CPC H01F 38/14; G06K 7/10059; G06K 7/10356; G03G 21/1882; G03G 21/1892

(57) ABSTRACT

Systems include a transceiver having a transceiver antenna, a transponder positioned a first distance from the transceiver, and an intermediate structure positioned a second distance from the transponder (where the first distance is greater than the second distance). The transponder has a transponder antenna, and the intermediate structure has an intermediate antenna (and a capacitor). The transponder antenna is a first size antenna (smallest), the intermediate antenna is a second size antenna (bigger), and the transceiver antenna is a third size antenna (biggest). The intermediate structure provides field lines between the transceiver antenna and the transponder antenna that the transponder antenna is otherwise incapable of fully receiving from the transceiver antenna. This causes the intermediate antenna to transfer voltage received from the transceiver antenna to the transponder antenna.

### BACKGROUND

Systems and methods herein generally relate to wireless communication systems and more particularly to proper coupling of devices using different sized antennas.

Wireless communication systems are used in many fields. For example, a replaceable unit monitor (RUM), such as a customer replaceable unit monitor/memory (CRUM) or an engineer replaceable unit monitor/memory (ERUM), is used to monitor the status of a replaceable unit (RU), such as a toner cartridge, or the like. A CRUM reader can access a CRUM and obtain information regarding the status of a customer replaceable unit (CRU) using wireless communications. A CRUM reader system may include a host processor and a coupler board that interfaces between the host processor and a CRUM using a wireless radio frequency identification (RFID) tag. Also, radio frequency identification technology provides mechanisms for validation of data integrity during data exchanges, such as cyclic redundancy check (CRC) values, between a coupler board and a tag.

### SUMMARY

Exemplary systems herein include (among other components) a transponder having a transponder antenna, a transceiver positioned a first distance from the transponder, and an intermediate structure positioned a second distance from the transponder (where the first distance is greater than the second distance). The transceiver has a transceiver antenna, and the intermediate structure has an intermediate antenna (and a capacitor). The transponder antenna is a first size antenna (smallest), the intermediate antenna is a second size antenna (bigger), and the transceiver antenna is a third size antenna (biggest). Thus, the antennas increase in size from the first to the third, with the third antenna being the largest.

The intermediate structure can include a flexible surface (that is connected to the intermediate antenna and the capacitor) that can potentially be self-adhesive (can include a self-adhesive material on at least one side of the flexible surface). The intermediate structure focuses field lines between the transceiver antenna and the transponder antenna that the transponder antenna is otherwise incapable of fully receiving from the transceiver antenna. More specifically, the transceiver antenna generates original field lines, the intermediate antenna focuses the original field lines, and the transponder antenna disturbs the focused original field lines to produce a response to the transceiver antenna.

Because of the different antenna sizes and the different spacing of the different devices, the transponder antenna receives more of the focused field lines from the intermediate antenna relative to the number of original field lines received from the transceiver antenna. To the contrary, the size of the intermediate antenna allows the intermediate antenna to receive more of the original field lines from the transceiver antenna relative to the number of original field lines the transponder antenna receives. This causes the intermediate antenna to transfer the voltage of the original field lines received from the transceiver antenna to the transponder antenna when the intermediate antenna focuses the field lines.

Additionally, the intermediate structure can include a capacitor connected to the intermediate antenna. The transceiver is a powered device connected to a continuous power supply, while the intermediate structure is a passive device powered by field lines received by the intermediate antenna, and the transponder is similarly a passive device powered by field lines received by the transponder antenna. The intermediate antenna builds voltage from the field lines received by the intermediate antenna from the transceiver antenna, and transfers the voltage to the transponder antenna.

Other devices herein include a printing device having, among other components, a printing engine, a controller directly or indirectly connected to the printing engine, and a coupling board directly or indirectly connected to the controller. The coupling board has a transceiver that has a transceiver antenna. Also, a replaceable unit is connected to the printing engine. The replaceable unit includes a transponder that has a transponder antenna, and the transceiver is positioned a first distance from the transponder.

An intermediate structure is directly or indirectly connected to the exterior of the replaceable unit and is positioned a second distance from the transponder. The first distance is greater than the second distance. Also the intermediate structure contains an intermediate antenna with a connected capacitor. Furthermore, the intermediate structure can include a potentially self-adhesive flexible surface connected to the intermediate antenna and the capacitor (that can have a self-adhesive material on at least one side of the flexible surface (e.g., a sticker). The self-adhesive flexible surface can be used to adhere the intermediate structure to the exterior of the replaceable unit, for example.

The intermediate structure focuses field lines between the transceiver antenna and the transponder antenna that the transponder antenna is otherwise incapable of fully receiving from the transceiver antenna. More specifically, the transceiver antenna generates original field lines, the intermediate antenna focuses the original field lines, and the transponder antenna disturbs the focused original field lines to produce a response to the transceiver antenna.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating systems herein;

FIG. 2 is a schematic diagram illustrating systems herein;

FIG. 3 is a schematic diagram illustrating systems herein;

FIG. 4 is a schematic diagram illustrating how the intermediate structure herein focuses magnetic field lines;

FIG. 5 is a schematic diagram illustrating how the intermediate structure herein focuses magnetic field lines;

FIG. 6 is a schematic diagram illustrating how the intermediate structure herein focuses magnetic field lines;

FIG. 7 is a schematic diagram illustrating how the intermediate structure herein focuses magnetic field lines;

FIG. 8 is a schematic diagram illustrating devices herein;

FIG. 9 is a schematic diagram illustrating devices herein;

FIG. 10 is a schematic diagram illustrating antenna herein;

FIG. 11 is a schematic diagram illustrating antenna herein;

FIG. 12 is a schematic diagram illustrating antenna herein; and

FIG. 13 is a schematic diagram illustrating antenna herein.

### DETAILED DESCRIPTION

As noted above, a customer replaceable unit monitor/memory (CRUM) can be used to monitor the status of a replaceable unit (RU) within a printing device, such as a toner cartridge, or the like. A CRUM reader can access a CRUM and obtain information regarding the status of a customer replaceable unit (CRU) using wireless communications. A CRUM reader system may include a host processor and a coupler board that interfaces between the host processor and a CRUM using a wireless radio frequency identification (RFID) tag.

Systems herein provide an intermediate coil (structure) and capacitor that help a RF (Radio Frequency) tag with a smaller footprint gather energy from a larger area. By having the tag close to the intermediate coil, the tag can be very strongly coupled to the coil. This permits more energy to be gathered by the intermediate coil to provide the tag with an effective larger surface area to allow the tag to interact with the magnetic field produced by the coupler board.

While the small tag can communicate with the larger coupler board, the communications are successfully conducted when the distance between a large coupler board and a small tag is a small distance (e.g., less than 10 mm, 5 mm, 1 mm, etc.). However, many structures position the tag a greater distance from the coupler board (e.g., more than 20 mm, 40 mm, 100 mm, etc.). At such greater distances, the larger footprint of the coupler board's antenna makes it difficult to couple with the smaller footprint of the tag. Therefore, the intermediate coil herein (the LC (inductor capacitor) circuit) effectively gathers the required energy needed for the tag to communicate with the coupler board. When this intermediate LC circuit is introduced near a small tag, the larger coupler board is able to communicate with the small tag at greater distances.

One or more capacitors are included with the intermediate coil so that a voltage builds across the intermediate coil and transfers the voltage to the smaller tag. This system also works in reverse, whereby the tag will then couple its response onto the intermediate coil, which then is transmitted more effectively to the coupler board.

The intermediate coil can be mounted on a self-adhesive, flexible substrate with a parallel capacitor. The self-adhesive “label” intermediate coil can be directly applied to the smaller CRUM footprint to improve communication performance relative to a standard of a larger tag.

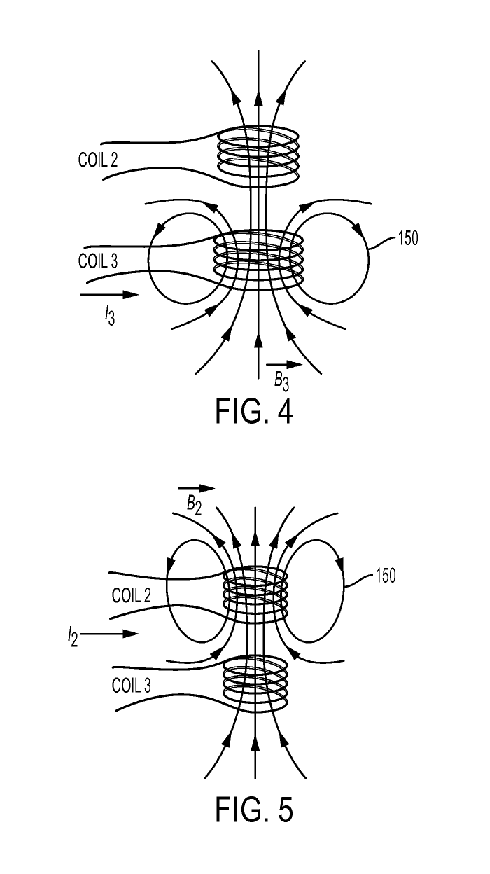

In addition to the intermediate coil building voltage and transferring the voltage to the smaller tag, the intermediate coil also compensates for mismatched aspect ratios between the antenna of the tag and the antenna of the coupler board. Field lines in a magnetic coupler are how the passive RFID of the tag and the active transceiver of coupler board communicate. These field lines bend outward (as seen in the FIG. 4 discussed below). When an RFID tag antenna has mismatched aspect ratios to the antenna of the coupler board, field lines are missed. For example, missed field lines occur when a larger antenna of a coupler board tries to communicate with a much smaller RFID coil antenna. However, the size of the intermediate coil helps the mismatched antennas be able to catch field lines that would otherwise be outside of their respective coil surface area because the large and small antennas can both receive and send field lines with the intermediate coil, even if they cannot receive and send field lines with each other.

Thus, in addition to the intermediate coil building voltage and transferring the voltage to the smaller tag (e.g., focusing energy to the tag in a similar way a lens focuses light), the intermediate coil also helps mitigate the negative effects of mismatched aspect ratios of the field lines. Effectively, the intermediate coil acts as a bridge between the large coupler coil and the small RFID tag.

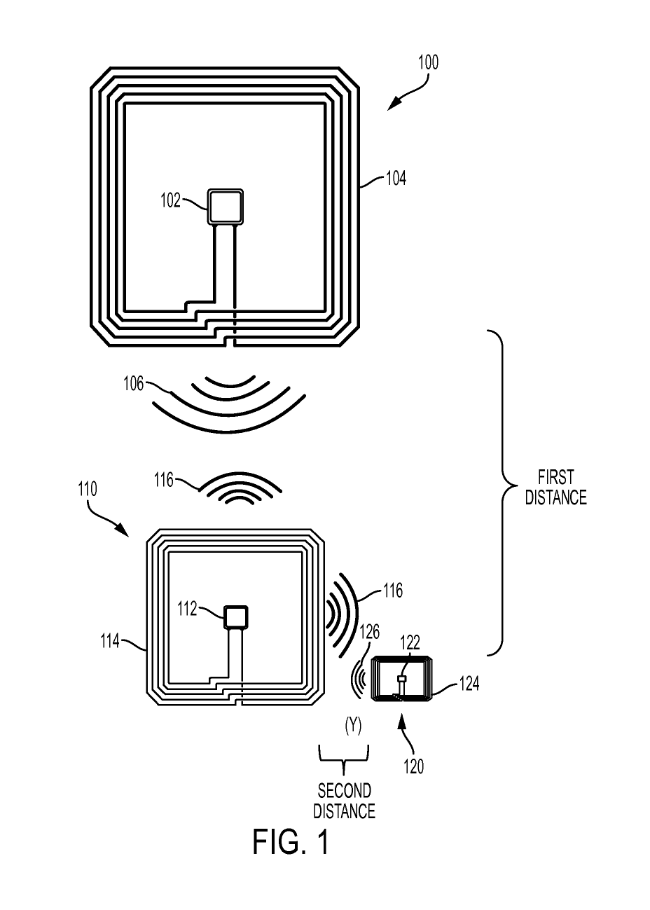

As shown in FIG. 1, exemplary systems herein include (among other components) a transponder 120 having a transponder antenna 124 and logic circuitry/capacitor 122. FIG. 1 also illustrates a transceiver 100 positioned a first distance (shown by bracket in the accompanying figures) from the transponder 120, and an intermediate structure 110 positioned a second distance (shown by bracket in the accompanying figures) from the transponder 120 (where the first distance is greater than the second distance). The intermediate structure 110 can be positioned between the transponder 120 and the transceiver 100, but does not need to be.

As shown in FIG. 1, the transceiver 100 has a transceiver antenna 104 (and powered logic circuitry 102), and the intermediate structure 110 has an intermediate antenna 114 (and a capacitor 112). The transponder antenna 124 is a first size antenna (smallest), the intermediate antenna 114 is a second size antenna (bigger), and the transceiver antenna 104 is a third size antenna (biggest). Thus, the antennas increase in size from the first to the third, with the third antenna being the largest.

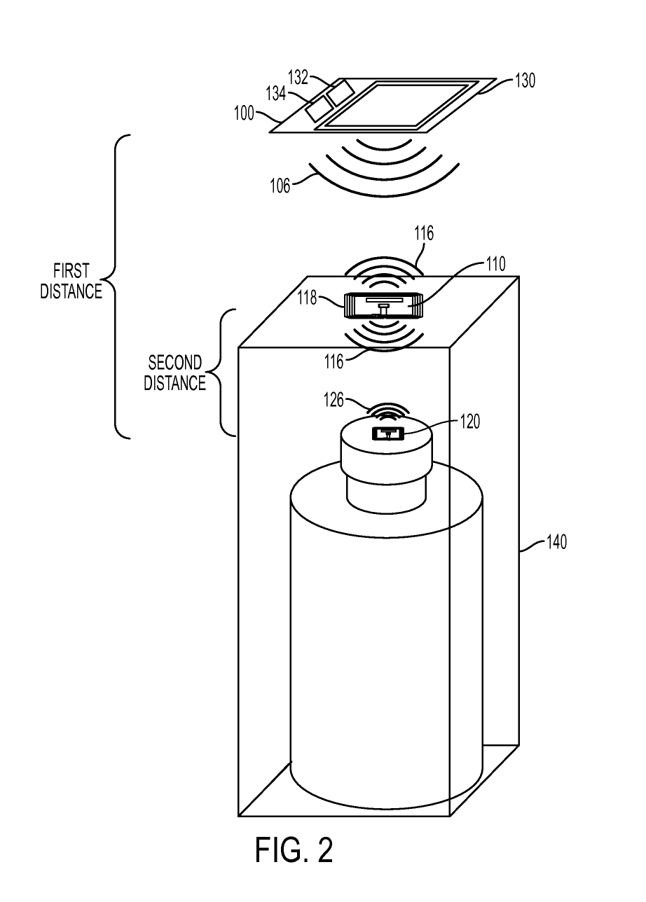

The intermediate structure 110 can include a flexible surface 118, shown in FIG. 2 (that is connected to the intermediate antenna 114 and the capacitor 112) that can potentially be self-adhesive (can include a self-adhesive material on at least one side of the flexible surface). Thus, the intermediate structure 110 can be an integrated circuit with the intermediate antenna 114 and the capacitor 112 formed on a flexible circuit board (FCB) 118.

Note that the intermediate structure 110 may not include any logic circuitry, but instead can be limited to only consisting of the flexible circuit board 118, the intermediate antenna 114, and the capacitor 112 (and the optionally a self-adhesive material). With such a limited number of components, such versions of the intermediate structure 110 are less expensive to manufacture, lighter, use less materials, are more environmentally friendly, etc. Further, the lack of logic circuitry in the passive intermediate structure 110 distinguishes the intermediate structure 110 from the powered transceiver 100 and the passive transponder 120, both of which include logic circuitry that allows the transceiver 100 and the transponder 120 to wirelessly communicate data information between each other.

The intermediate structure 110 focuses the magnetic field lines between the transceiver antenna 104 and the transponder antenna 124 that the transponder antenna 124 is otherwise incapable of fully receiving from the transceiver antenna 104 because the smaller size of the transponder antenna 124 prevents the transponder antenna 124 from inductively receiving voltage from the larger magnetic fields lines generated by the transceiver antenna 104. More specifically, the transponder antenna 124 disturbs the focused magnetic field lines to produce disturbed magnetic field lines 126.

Because of the different antenna sizes and the different distance spacing of the different devices, the transponder antenna 124 receives more of the focused magnetic field lines 116 from the intermediate antenna 114 relative to the number of original magnetic field lines 106 received from the transceiver antenna 104. To the contrary, the size of the intermediate antenna 114 allows the intermediate antenna 114 to receive more of the original magnetic field lines 106 from the transceiver antenna 104 relative to the number of original magnetic field lines 106 the transponder antenna 124 receives. This causes the intermediate antenna 114 to inductively transfer the voltage (power) of the original magnetic field lines 106 received from the transceiver antenna 104 to the transponder antenna 124 when the intermediate antenna 114 provides the focused magnetic field lines 116 using the voltage from the original magnetic field lines 106. The voltage inductively transferred from the intermediate antenna 114 to the transponder antenna 124 is further aided by the capacitor 112 of the intermediate structure 110 because the capacitor 112 stores or accumulates the voltage (power) that is received from the transceiver 100 to allow more voltage to be inductively transferred to the transponder 120.

In even greater detail, the transponder antenna 124 comprises a first planar coil of one or more non-intersecting first wires. The intermediate antenna 114 comprises a second planar coil of one or more non-intersecting second wires. The transceiver antenna 104 comprises a third planar coil of one or more non-intersecting third wires.

Additionally, the intermediate structure 110 can include a capacitor 112 connected to the intermediate antenna 114. As noted above, the capacitor 112 stores or accumulates the voltage (power) that is received from the transceiver 100 to allow more voltage to be inductively transferred to the transponder 120. The transceiver 100 is a powered device connected to a continuous power supply, while the intermediate structure 110 is a passive device powered by magnetic field lines received by the intermediate antenna 114, and the transponder 120 is similarly a passive device powered by magnetic field lines received by the transponder antenna 124. The intermediate antenna 114 builds voltage from the magnetic field lines received by the intermediate antenna 114 from the transceiver antenna 104, and inductively transfers the voltage to the transponder antenna 124.

Additionally, while the intermediate structure 110 is useful in focusing field lines from the transceiver 100 to transfer such voltage to the transponder 120, the intermediate structure 110 also acts as a intermediate data transfer structure (e.g., a repeater) because the magnetic field lines operate at a specific frequency and contain data. Thus, the transceiver 100 includes data within the original magnetic field lines 106, and such data is received by the intermediate structure 110 and repeated in the focused magnetic field lines 116 that are focused by the intermediate structure 110 and received by the transponder 120. The transponder 120 processes the received data, using the logic within the circuitry 122, and provides a response if necessary by disturbing the original magnetic fields lines (shown as disturbed magnetic field lines 126 that contain altered data). The intermediate structure 110 receives the altered data within the disturbed magnetic field lines 126 that were disturbed by the transponder 120. The transceiver 100 then evaluates the altered data of the disturbed magnetic field lines 126 for various purposes, such as authentication, data capture, etc.

FIG. 2 illustrates another example of how the systems herein could be implemented. The same identification numerals are used to identify the same items in more of the Figures. In FIG. 2, item 130 is a coupler board and item 140 is a replaceable unit, such as a drum or toner cartridge within a printing device. The coupler board includes various logic circuitry 132, the powered transceiver 100, and a power supply 134 all of which are directly or indirectly connected to one another.

As shown in FIG. 2, the transceiver 100 an integral element of the coupler board 130. Similarly, the transponder 120 is shown as being an integral element of the replaceable unit 140. The intermediate structure 110 is shown as being attached to the exterior of the replaceable unit 140. More specifically, the flexible circuit board 118 is a self-adhesive sticker allowing the intermediate structure 110 to be easily applied (but permanently retained thereafter) to the outer surface of the replaceable unit 140.

As also shown in FIG. 2, the transponder 120 is the first distance from the transceiver 100 and the intermediate structure 110 is the second distance from the transponder 120. As shown in FIG. 2 (and as was similarly shown in FIG. 1) the second distance is less than the first distance, meaning that the intermediate structure 110 is closer to the transponder 120 than to the transceiver 100. In this example, the intermediate structure 110 is actually partially or indirectly between the transponder 120 and the transceiver 100; however, as noted above, the intermediate structure 110 does not need to be directly between the other structures.

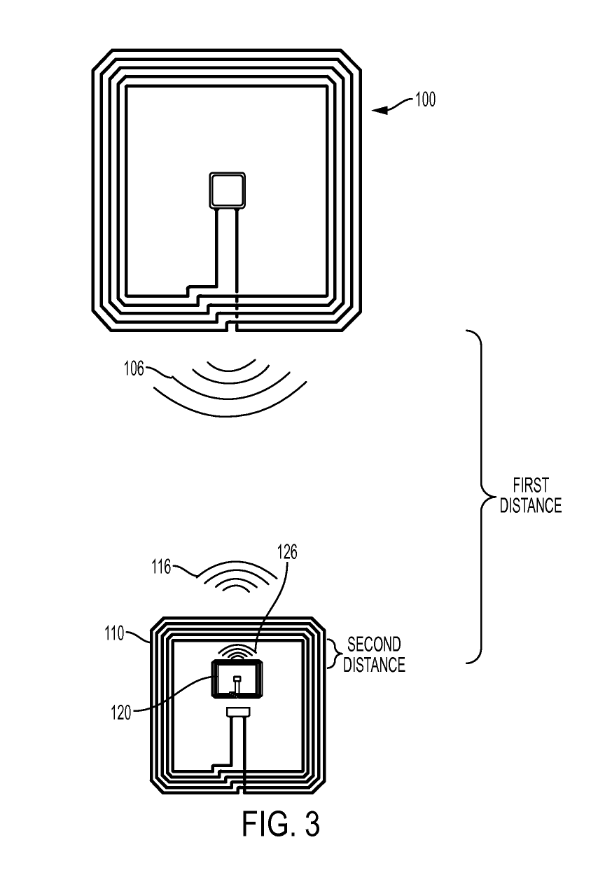

FIG. 3 illustrates another example of how the systems herein could be implemented. The same identification numerals are again used to identify the same items in more of the Figures. FIG. 3 illustrates the transponder 120 positioned within the intermediate structure 110. Note that this positioning still maintains the first distance as being larger than the second distance. In the example shown in FIG. 3, the intermediate structure 110 could be attached to the exterior of the transponder 120, for example, using the self-adhesive flexible circuit board 118 or any attachment mechanism (tape, glue, rivet, screw, solder, bonding agent, etc., all of which are represented by item 118).

As described above, in FIGS. 2 and 3, the size of the intermediate structure 110 allows the intermediate antenna 114 to receive more of the original magnetic field lines 106 from the transceiver 100. This causes the intermediate structure 110 to inductively transfer the voltage of the original magnetic field lines 106 received from the transceiver 100 to the transponder 120 when the intermediate structure 110 focuses the magnetic field lines 116 using the voltage from the original magnetic field lines 106.

While a limited number of examples have been presented in FIGS. 1-3, those ordinarily skilled in the art would understand that many other positions of the various devices, other sizes of the various devices, other spacings of the various devices, could be used to accommodate many different types of structures. Further, while a printing device has been used in some examples herein, the systems herein are not limited to printing devices, but instead are applicable to all devices that utilize wireless communications where different spacings and/or different sizes of the devices' antennas results in improper or incomplete coupling of the magnetic field lines. Therefore, the systems herein can be applied to any device that utilizes wireless communications, and provide a passive device to help focus the energy (sometimes referred to herein as voltage or power) inductively transferred from the powered antenna to the passive antenna.

FIGS. 4-7 illustrate how the intermediate structure focuses the magnetic field lines using the voltage from the original magnetic field lines. As shown in FIG. 4, when coil 3 (transceiver) is excited (by current I₃,) it generates a magnetic field 150 around the coil conductor (B₃). As shown in FIG. 4, the field lines 150 wrap around the loop. Because coils 3 and 2 are in close proximity, some of the field lines 150 will go through the coil 2. This magnetic field 150 will thus induce a current on coil 2, which in turns generates a magnetic field on coil 2.

As shown in FIG. 4, the field lines 150 of a loop antenna go through the center of the coil and spread as they exit the loop. Given an antenna with a fixed area, the closer it is to the excited antenna the more field lines 150 will cut through it and therefore the intensity of magnetic flux it sees will be higher. Similarly, FIG. 5 illustrates that, at a fixed distance between the coils 2 and 3, the larger the diameter of coil 2 (relative to coil 3) the higher the intensity of the magnetic flux (B₂) coil 2 sees (shown as current I₂).

For a passive device such as an RFID to function properly it should be in the presence of a strong magnetic flux. In general, as shown in the FIGS. 4-5, the diameter of the transceiver (coil 3) and the transponder coils (coil 2) can be designed to have similar diameters. As the transponder coil 3 diameter decreases the transceiver coil 2 diameter can be similarly decreased for proper operation, due to the reduced surface area of the loop. By positioning an intermediate coil, closely spaced to the transponder coil (see FIG. 7 below) it is possible to increase the distance between transponder and transceiver and still communicate with the device.

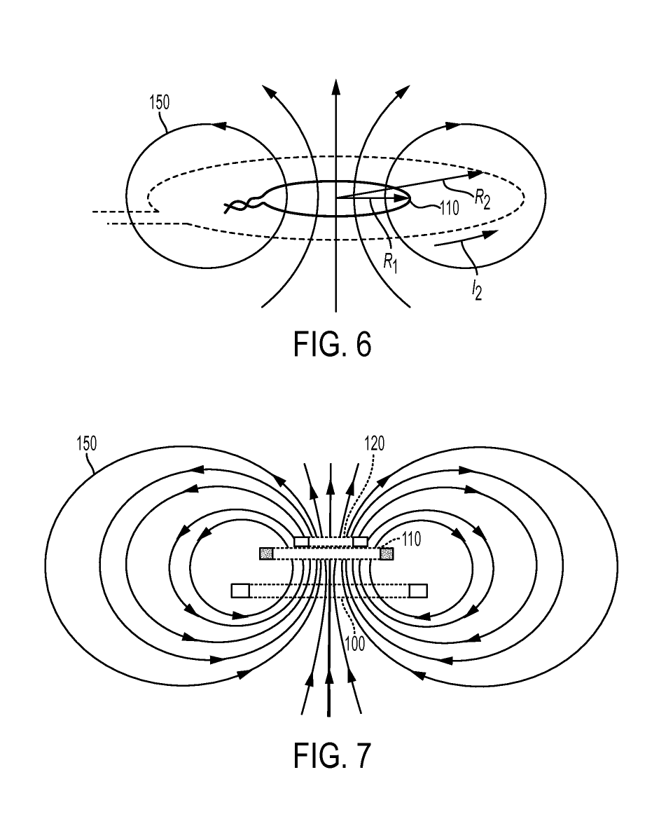

As shown in FIG. 6, the intermediate coil 110 has a diameter similar to the transceiver coil such that it can collect a stronger magnetic field 150 from the transceiver. The intermediate coil 110 does not have a load but is connected in parallel with a capacitor to allow the intermediate coil 110 to resonate at the frequency of the transceiver. With the smaller transponder coil in the center of the intermediate coil (R₁ vs. R₂), the transponder coil is in an area of strong magnetic flux as the magnetic field lines 150 go through the center of the intermediary coil. This allows for the smaller transponder coil to collect enough energy to communicate over distance d from the transponder. In FIG. 6, R₁ corresponds to the transponder coil radius, R₂ corresponds to the intermediary coil radius and R₃ (not shown) correspond to the radius of the transceiver coil. R₁<R₂. R₂ is very similar to R₃.

Therefore, as shown in FIG. 7, various magnetic field lines 150 are generated by the transceiver 100. As shown in FIG. 7, the larger size of the intermediate structure 110 allows the intermediate structure 110 to intersect more of the magnetic field lines 150 relative to the number of magnetic field lines the smaller transponder 120 intersects. In this example, the transponder 120 does not intersect more of the magnetic field lines 150; however, the intermediate structure 110 does intersect more of the magnetic fields lines 150, allowing the intermediate structure 110 to inductively obtain more of the voltage within the magnetic field lines 150 relative to the amount of voltage that the transponder 120 would be able to inductively receive.

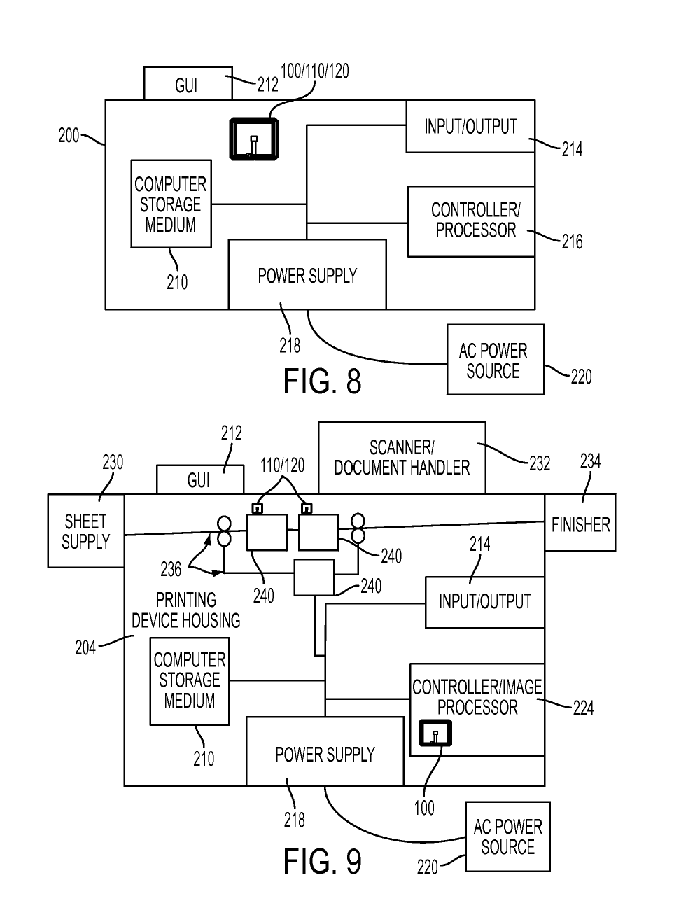

FIG. 8 illustrates a computerized device 200, which can be used with systems and methods herein and can comprise, for example, a print server, a personal computer, a portable computing device, etc. The computerized device 200 includes a controller/tangible processor 216 and a communications port (input/output) 214 operatively connected to the tangible processor 216 and to the computerized network external to the computerized device 200. Also, the computerized device 200 can include at least one accessory functional component, such as a graphical user interface (GUI) assembly 212. The user may receive messages, instructions, and menu options from, and enter instructions through, the graphical user interface or control panel 212.

The input/output device 214 is used for communications to and from the computerized device 200 and comprises a wired device or wireless device (of any form, whether currently known or developed in the future). The tangible processor 216 controls the various actions of the computerized device. A non-transitory, tangible, computer storage medium device 210 (which can be optical, magnetic, capacitor 112 based, etc., and is different from a transitory signal) is readable by the tangible processor 216 and stores instructions that the tangible processor 216 executes to allow the computerized device to perform its various functions, such as those described herein. Thus, as shown in FIG. 8, a body housing has one or more functional components that operate on power supplied from an alternating current (AC) source 220 by the power supply 218. The power supply 218 can comprise a common power conversion unit, power storage element (e.g., a battery, etc), etc.

As shown in FIG. 8, the computerized device 200 also includes the structures illustrated in FIGS. 1-3, discussed above. These items are identified using reference numerals 100/110/120, and such is intended to represent one or more of any of the transceiver, transponder, intermediate structures discussed above.

FIG. 9 illustrates a computerized device that is a printing device 204, which can be used with systems and methods herein and can comprise, for example, a printer, copier, multi-function machine, multi-function device (MFD), etc. The printing device 204 includes many of the components mentioned above and at least one marking device (printing engine(s)) 240 operatively connected to a specialized image processor 224 (that is different from a general purpose computer because it is specialized for processing image data), a media path 236 positioned to supply continuous media or sheets of media from a sheet supply 230 to the marking device(s) 240, etc. After receiving various markings from the printing engine(s) 240, the sheets of media can optionally pass to a finisher 234 which can fold, staple, sort, etc., the various printed sheets. Also, the printing device 204 can include at least one accessory functional component (such as a scanner/document handler 232 (automatic document feeder (ADF)), etc.) that also operate on the power supplied from the external power source 220 (through the power supply 218).

The one or more printing engines 240 are intended to illustrate any marking device that applies a marking material (toner, inks, etc.) to continuous media or sheets of media, whether currently known or developed in the future and can include, for example, devices that use a photoreceptor belt or an intermediate transfer belt, or devices that print directly to print media (e.g., inkjet printers, ribbon-based contact printers, etc.).

As shown in FIG. 9, the printing device 204 also includes the structures illustrated in FIGS. 1-3, discussed above. These items are identified using reference numerals 100 and 110/120, and such is intended to represent one or more of any of the transceiver, transponder, intermediate structures discussed above. More specifically, similar to the arrangement shown in FIG. 2, in FIG. 9, the controller 224 (which could include or could be a coupler board) includes a powered transceiver 100. Additionally, various elements within the printing engines 240 (such as replaceable units, etc.) could include the intermediate structure 110 and the transponder 120 in various positions, such as those shown in FIG. 2, discussed above.

Thus, other devices herein include a printing device 204 having, among other components, a printing engine 240, a controller 224 directly or indirectly connected to the printing engine 240, and a coupling board 130 directly or indirectly connected to the controller 224. The coupling board 130 has a transceiver 100 that has a transceiver antenna 104. Also, a replaceable unit 140 is connected to the printing engine 240. The replaceable unit 140 includes a transponder 120 that has a transponder antenna 124, and the transceiver 100 is positioned a first distance from the transponder 120.

An intermediate structure 110 is directly or indirectly connected to the exterior of the replaceable unit 140 and is positioned a second distance from the transponder 120. The first distance is greater than the second distance. Also, the intermediate structure 110 contains an intermediate antenna 114 with a connected capacitor 112. Furthermore, the intermediate structure 110 can include a potentially self-adhesive flexible surface 118 connected to the intermediate antenna 114 and the capacitor 112 (that can have a self-adhesive material on at least one side of the flexible surface 118 (e.g., a sticker)). The self-adhesive flexible surface 118 can be used to adhere the intermediate structure 110 to the exterior of the replaceable unit 140, for example.

The intermediate structure 110 focuses the magnetic field lines between the transceiver antenna 104 and the transponder antenna 124 that the transponder antenna 124 is otherwise incapable of fully receiving from the transceiver antenna 104. More specifically, the transponder antenna 124 disturbs the focused magnetic field lines to produce disturbed magnetic field lines 126, the intermediate antenna 114 generates focused magnetic field lines 116, and the transceiver antenna 104 generates original magnetic field lines 106.

Because of the different antenna sizes and the different spacing of the different devices, the transponder antenna 124 receives more of the focused magnetic field lines 116 from the intermediate antenna 114 relative to the number of original magnetic field lines 106 received from the transceiver antenna 104. To the contrary, the size of the intermediate antenna 114 allows the intermediate antenna 114 to receive more of the original magnetic field lines 106 from the transceiver antenna 104 relative to the number of original magnetic field lines 106 the transponder antenna 124 receives. This causes the intermediate antenna 114 to transfer the voltage of the original magnetic field lines 106 received from the transceiver antenna 104 to the transponder antenna 124 when the intermediate antenna 114 produces the focused magnetic field lines 116 using the voltage from the original magnetic field lines 106.

Additionally, the intermediate structure 110 can include a capacitor 112 connected to the intermediate antenna 114. The transceiver 100 is a powered device connected to a continuous power supply 134, while the intermediate structure 110 is a passive device powered by magnetic field lines received by the intermediate antenna 114, and the transponder 120 is similarly a passive device powered by magnetic field lines received by the transponder antenna 124. The intermediate antenna 114 builds voltage from the magnetic field lines received by the intermediate antenna 114 from the transceiver antenna 104, and transfers the voltage to the transponder antenna 124.

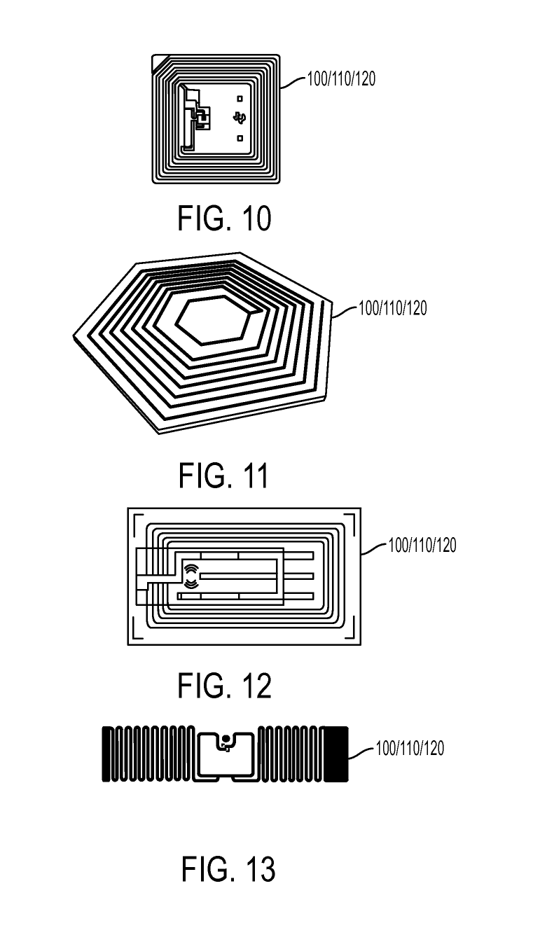

In the structures herein, the antennas can be of any shape and size. FIGS. 10-13 illustrate some exemplary shapes of antennas that can be used with devices herein. In these examples, FIG. 10 illustrates a square planar antenna of non-overlapping coils, FIG. 11 illustrates a pentagon planar antenna of non-overlapping coils, FIG. 12 illustrates a rectangular planar antenna of non-overlapping coils, and FIG. 13 illustrates a planar antenna of non-overlapping S-shaped coils. Those ordinarily skilled in the art would understand that these are only examples, and that antennas can be of any shape and size can be used with structures herein.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, printers, copiers, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., may be used herein and are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A system comprising:
a transponder having a transponder antenna;
a transceiver positioned a first distance from said transponder; and
an intermediate structure positioned a second distance from said transponder,
said transceiver having a transceiver antenna,
said intermediate structure having an intermediate antenna,
said first distance being greater than said second distance,
said transponder antenna being a first size,
said intermediate antenna being a second size,
said transceiver antenna being a third size,
said second size being greater than said first size, and
said third size being greater than said second size.

2. The system according to claim 1, said intermediate structure further comprising a flexible surface connected to said intermediate antenna and a capacitor.

3. The system according to claim 2, further comprising a self-adhesive material on at least one side of said flexible surface.

4. The system according to claim 1, said intermediate structure focusing field lines between said transceiver antenna and said transponder antenna that said transponder antenna is otherwise incapable of fully receiving from said transceiver antenna.

5. The system according to claim 1, said transceiver generating original field lines.

6. The system according to claim 5, said intermediate antenna focusing said original field lines to generate focused field lines and said transponder antenna disturbing original field lines to produce a response to said transceiver antenna.

7. The system according to claim 5, said intermediate antenna transferring voltage in said original field lines received from said transceiver antenna to said transponder antenna.

8. A system comprising:
a transponder having a transponder antenna;
a transceiver positioned a first distance from said transponder; and
an intermediate structure positioned a second distance from said transponder,
said transceiver having a transceiver antenna,
said intermediate structure having an intermediate antenna and a capacitor connected to said intermediate antenna,
said transceiver comprising a powered device connected to a continuous power supply,
said intermediate structure comprising a passive device powered by field lines received by said intermediate antenna,
said transponder comprising a passive device powered by field lines received by said transponder antenna,
said intermediate antenna building voltage from said field lines received by said intermediate antenna from said transceiver antenna and transferring said voltage to said transponder antenna,
said first distance being greater than said second distance,
said transponder antenna being a first size,
said intermediate antenna being a second size,
said transceiver antenna being a third size,
said second size being greater than said first size, and
said third size being greater than said second size.

9. The system according to claim 8, said intermediate structure further comprising a flexible surface connected to said intermediate antenna and said capacitor.

10. The system according to claim 9, further comprising a self-adhesive material on at least one side of said flexible surface.

11. The system according to claim 8, said intermediate structure focusing field lines between said transceiver antenna and said transponder antenna that said transponder antenna is otherwise incapable of fully receiving from said transceiver antenna.

12. The system according to claim 8, said transceiver generating original field lines.

13. The system according to claim 12, said intermediate antenna focusing said original field lines to generate focused field lines and said transponder antenna disturbing original field lines to produce a response to said transceiver antenna.

14. The system according to claim 12, said intermediate antenna transferring voltage in said original field lines received from said transceiver antenna to said transponder antenna.

15. A printing device comprising:
a printing engine;
a controller operatively connected to said printing engine;
a coupling board operatively connected to said controller, said coupling board comprising a transceiver having a transceiver antenna;
a replaceable unit connected to said printing engine, said replaceable unit comprising a transponder, said transceiver being positioned a first distance from said transponder; and
an intermediate structure connected to an exterior of said replaceable unit and being positioned a second distance from said transponder,
said transponder having a transponder antenna,
said intermediate structure having an intermediate antenna and a capacitor connected to said intermediate antenna,
said first distance being greater than said second distance,
said transponder antenna being a first size,
said intermediate antenna being a second size,
said transceiver antenna being a third size,
said second size being greater than said first size, and
said third size being greater than said second size.

16. The printing device according to claim 15, said intermediate structure further comprising a flexible surface connected to said intermediate antenna and said capacitor.

17. The printing device according to claim 16, further comprising a self-adhesive material on at least one side of said flexible surface.

18. The printing device according to claim 15, said intermediate structure focusing field lines between said transceiver antenna and said transponder antenna that said transponder antenna is otherwise incapable of fully receiving from said transceiver antenna.

19. The system according to claim 15, said transceiver generating original field lines, said intermediate antenna focusing said original field lines to generate focused field lines, and said transponder antenna disturbing original field lines to produce a response to said transceiver antenna.

20. The system according to claim 15, said transceiver generating original field lines, said intermediate antenna transferring voltage in said original field lines received from said transceiver antenna to said transponder antenna.
